(19) United States
(12) Patent Application Publication
(10) Pub. No.: US 2003/0173698 A1
(43) Pub. Date: Sep. 18, 2003

(54) Elasticity-processing method for wet suit fabric pieces

(76) Inventor: Chi-Chou Chuang, Dong Shan Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/098,538

(22) Filed: Mar. 18, 2002

(51) Int. Cl. B32B 31/00; B28B 7/14; B27N 3/10; B29C 31/00; D01D 5/16; B63C 11/04; B63C 11/10; D03D 15/08; D03D 17/00

(52) U.S. Cl. 264/139; 264/163; 264/257; 264/290.7; 2/2.15; 442/182

(57) ABSTRACT

An elasticity-processing method for wet suit fabric pieces is disclosed, by which a wet suit fabric piece laminated with a knitted high-elastic cloth is pressed tightly with two sets of rubber squeeze rollers under different rotation speeds to cause an expansion effect on the fabric piece, separate and destroy the weave circle of the weave of the knitted cloth and produce an elasticity to the whole piece of the fabric. In comparison with the conventional low-elastic and high-modulus wet suit fabric pieces, the fabric pieces made with such a process has a high elasticity and low modulus, and is capable to improve the elasticity of wet suits in professional applications. The wet suits made of such fabric are more fitted, softer and more comfortable.

### BACKGROUND OF THE INVENTION

1. Field of the Invention

The present invention relates to an elasticity-processing method for wet suit fabric pieces, more particularly to a method for production of wet suit fabric pieces having high elasticity and improving the quality of wet suits and related products.

2. The Related Art

Traditionally, fabric pieces for production of wet suits are one-sided knitted cloth made of 100% nylon and laminated with an artificial rubber sponge. However, since wet suits must be a good fit, the conventional wet suits made of the aforementioned fabric pieces, that have only low elasticity, restricts the movement of the joints of a wearer of the wet suit. In addition, since each part of the human body is different, the constraint needed for individual parts of the human body is variable. The conventional wet suits are not capable to meet this demand and make wearers uncomfortable due to poor fit of such wet suits.

The present invention provides an elasticity-processing method for the production of wet suit fabric pieces that have high elasticity, improving the quality of the wet suit products and alleviating the disadvantages of the conventional wet suit fabric pieces.

### SUMMARY OF THE INVENTION

A wet suit fabric piece laminated with a knitted high-elastic cloth is pressed tightly with two sets of rubber squeeze rollers under different rotation speeds to cause an expansion effect on the fabric piece, separating and destroying the weave circle of the weave of the knitted cloth and producing an elasticity to the whole piece of the fabric. In comparison with the conventional low-elastic and high-modulus wet suit fabric pieces, the fabric pieces of the present invention made in such process has a high elasticity and low modulus, and is capable to provide better flexibility for each joint of a wearer and reduce uncomfortable constraint on individual parts of the wearer's body. The wet suits made of such fabric are more fitted, softer and more comfortable.

The present invention will be described in details with reference to the attached drawings, in which:

### BRIEF DESCRIPTION OF THE DRAWINGS

FIG. 1 is a schematic view of a rubber squeeze roller process of the present invention;

FIG. 2A is a schematic view of a weave before the rubber squeeze roller process; and

FIG. 2B is a schematic view of a weave after the rubber squeeze roller process.

### DETAILED DESCRIPTION OF PREFERRED EMBODIMENT

The elasticity-processing method for wet suit fabric pieces of the present invention is mainly a rubber squeeze roller process.

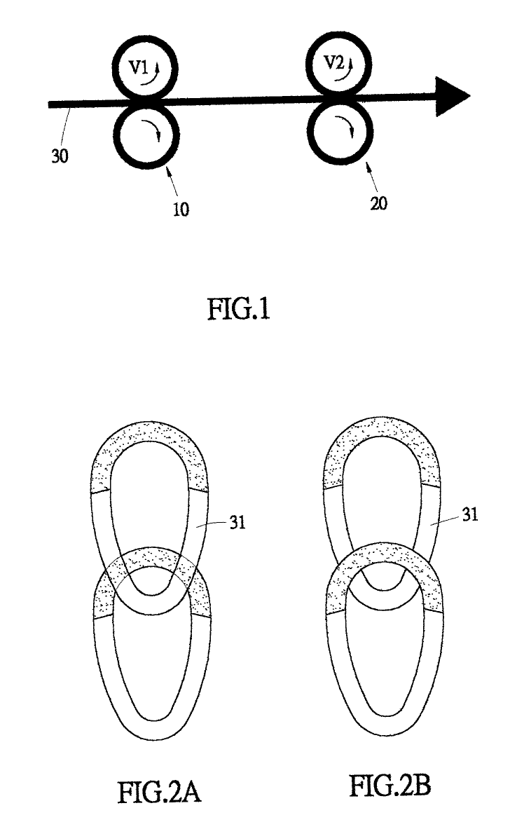

As shown in FIG. 1, a wet suit fabric piece 30 made of artificial rubber and laminated with a knitted high-elastic cloth is treated in the rubber squeeze roller process, and the weave circle 31 of the weave of the knitted cloth is separated and destroyed to produce an elasticity to the whole piece of the fabric 30.

Two sets of rubber squeeze rollers 10, 20 with different rotation speeds are used to press the wet suit fabric piece 30 tightly. The rotation speed of the first set of squeeze roller 10 is V1, which is lower than the rotation speed of the second set of squeeze roller 20, designated by V2. The difference between V1 and V2 (V2>V1) produces an expansion effect on the wet suit fabric piece 30, and separates and destroys the weave circle 31 of the weave of the elastic knitted cloth laminated on the wet suit fabric piece 30.

However, thanks to an adhesive effect of a paste, the inner layer of the knitted cloth is not destroyed when the weave circle 31 of the weave of the knitted cloth laminated on the wet suit fabric piece 30 is separated and destroyed in the aforementioned process. Instead, the fabric weave of such inner layer becomes an elastic terry weave under the recovery action of the artificial rubber sponge to give a high-elastic and low-modular feature to the wet suit fabric piece 30.

By using the method of the present invention, a high-elastic and low-modulus wet suit fabric piece is produced that is capable to improve the elasticity of wet suits. In the application to professional wet suits, the present invention is more comfortable, flexible and fitted for wearers in comparison with conventional low-elastic and high-modulus wet suit fabric pieces.

Although the substantial functions and uniqueness of the present invention has been illustrated and described with reference to the preferred embodiment thereof, it should be under stood that it is in no way limited to the details of such embodiment but is capable of numerous modifications within the scope of the appended claims.

What is claimed is:

1. An elasticity-processing method for wet suit fabric pieces by which a wet suit fabric piece made of artificial rubber and laminated with an elastic knitted cloth becomes elastic, comprising:
a squeeze roller process in which two sets of squeeze rollers with different rotation speeds are used to press said wet suit fabric piece tightly; the first set of squeeze rollers having a first rotation speed and the second set of squeeze rollers having a second rotation speed that is greater than the first rotation speed whereby a difference between the first and second rotation speeds causes an expansion effect on said wet suit fabric piece, and separating and destroying a weave circle of a weave of said elastic knitted cloth laminated on said wet suit fabric piece; an inner layer of said knitted cloth being not destroyed by said expansion effect and becoming an elastic terry weave under a recovery action of the artificial rubber sponge to give a high-elastic and low-modular feature to said wet suit fabric piece.
